(19) United States
(12) Patent Application Publication
(10) Pub. No.: US 2024/0064487 A1
(43) Pub. Date: Feb. 22, 2024

(54) CUSTOMIZED SELECTIVE ATTENUATION OF GAME AUDIO

(71) Applicant: Sony Interactive Entertainment Inc., Tokyo (JP)

(72) Inventors: Satish Uppuluri, Dublin, CA (US); Jason Grimm, Sunnyvale, CA (US)

(21) Appl. No.: 17/890,171

(22) Filed: Aug. 17, 2022

(51) Int. Cl. H04S 7/00; A63F 13/54; G10L 25/51

(52) U.S. Cl. CPC H04S 7/307; A63F 13/54; G10L 25/51; A63F 2300/6081

(57) ABSTRACT

In customized audio attenuation a computer system generates audible sounds in one or more frequency ranges from electronic signals. An audiogram for a listener is inferred from the listener's response to the audible sounds and an attenuation profile is determined from the audiogram. The attenuation profile includes an attenuation level for each of the one or more frequency ranges. Each attenuation level is inversely related to the listener's sensitivity to hearing sounds in the corresponding frequency range. Subsequent signals or data corresponding to subsequent audible sounds in the one or more frequency ranges are generated. The attenuation profile is applied to the subsequent signals to generate attenuated signals and the attenuated signals are transmitted to an audio transducer.

### FIELD OF THE DISCLOSURE

Aspects of the present disclosure relate to video games and more specifically to selective attenuation of audio in video games.

### BACKGROUND OF THE DISCLOSURE

Modern video game systems can produce high quality audio output in addition to video images. Modern video game consoles can support four channel (3.1) surround sound, six channel (5.1) surround sound or eight channel (7.1) surround sound played through speakers or over headphones. Many systems can support multiple audio formats. Each format can be characterized by multiple different settings that can be adjusted to optimize the sound experienced by the user. For example, some consoles allow the user to select different formats for games and for video. Another audio setting may allow the user to turn the music that plays in the background on their home screen on and off or turn on and turn off sounds heard during some functions such as scrolling. Other settings may apply when specific output devices, such as headsets or AV amplifiers are used. For example, there may be audio settings that determine whether three dimensional (3D) audio is used, what profile of 3D audio is used, and settings that adjust how loud the user's own voice is heard through the headset. There may also be settings that determine the number of channels that an AV amplifier uses.

Although many audio settings are user-adjustable, the process of selecting the settings is often manual, complicated, and time consuming.

It is within this context that aspects of the present disclosure arise.

### BRIEF DESCRIPTION OF THE DRAWINGS

The teachings of the present disclosure can be readily understood by considering the following detailed description in conjunction with the accompanying drawings, in which:

FIG. 1 is a flow diagram depicting a method of customized audio attenuation according to an aspect of the present disclosure.

FIG. 2 depict graphs illustrating examples of an audiogram (upper) and an attenuation profile (lower) according to aspects of the present disclosure.

FIG. 3 depicts a graph illustrating an example of applying an attenuation profile to signals or data corresponding to audible sounds according to aspects of the present disclosure.

FIG. 4 is a schematic block diagram of a customized audio attenuation system according to aspects of the present disclosure.

### DESCRIPTION OF THE SPECIFIC EMBODIMENTS

Although the following detailed description contains many specific details for the purposes of illustration, anyone of ordinary skill in the art will appreciate that many variations and alterations to the following details are within the scope of the invention. Accordingly, the exemplary embodiments of the invention described below are set forth without any loss of generality to, and without imposing limitations upon, the claimed invention.

While numerous specific details are set forth in order to provide a thorough understanding of embodiments of the disclosure, it will be understood by those skilled in the art that other embodiments may be practiced without these specific details. In other instances, well-known methods, procedures, components and circuits have not been described in detail so as not to obscure the present disclosure. Some portions of the description herein are presented in terms of algorithms and symbolic representations of operations on data bits or binary digital signals within a computer memory. These algorithmic descriptions and representations may be the techniques used by those skilled in the data processing arts to convey the substance of their work to others skilled in the art.

An algorithm, as used herein, is a self-consistent sequence of actions or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

Unless specifically stated or otherwise as apparent from the following discussion, it is to be appreciated that throughout the description, discussions utilizing terms such as “processing”, “computing”, “converting”, “reconciling”, “determining” or “identifying,” refer to the actions and processes of a computer platform which is an electronic computing device that includes a processor which manipulates and transforms data represented as physical (e.g., electronic) quantities within the processor's registers and accessible platform memories into other data similarly represented as physical quantities within the computer platform memories, processor registers, or display screen.

A computer program may be stored in a computer readable storage medium, such as, but not limited to, any type of disk including floppy disks, optical disks (e.g., compact disc read only memory (CD-ROMs), digital video discs (DVDs), Blu-Ray Discs™, etc.), and magnetic-optical disks, read-only memories (ROMs), random access memories (RAMs), EPROMs, EEPROMs, magnetic or optical cards, flash memories, or any other type of non-transitory media suitable for storing electronic instructions.

The terms “coupled” and “connected,” along with their derivatives, may be used herein to describe structural relationships between components of the apparatus for performing the operations herein. It should be understood that these terms are not intended as synonyms for each other. Rather, in particular embodiments, “connected” may be used to indicate that two or more elements are in direct physical or electrical contact with each other. In some instances, “connected”, “connection”, and their derivatives are used to indicate a logical relationship, e.g., between node layers in a neural network (NN). “Coupled” may be used to indicated that two or more elements are in either direct or indirect (with other intervening elements between them) physical or electrical contact with each other, and/or that the two or more elements co-operate or communicate with each other (e.g., as in a cause an effect relationship).

### Introduction

A common issue with audio settings is that human hearing is often subjective. What sounds optimal to one listener may not be optimal for another. Audio settings do not always capture the variability in the human perception of sound. The human auditory system is sensitive to frequencies from about 20 Hz to a maximum of around 20,000 Hz, although the upper hearing limit decreases with age. Within this audible frequency range, the human ear is most sensitive between 2 and 5 kHz, largely due to the resonance of the ear canal and the transfer function of the ossicles of the middle ear. A given person's sensitivity to sound may vary with the pitch or frequency of sound within the audible frequency range.

Computer-based audio systems such as those found in video game consoles and similar devices are able to generate sound waveforms that include frequencies in the audible range and can selectively apply filters to sub-ranges of frequencies in the audible range. The filters shape the frequency spectrum of audio output signals by attenuating sounds in different sub-ranges of the spectrum by different amounts. Attenuating sounds refers to reducing the intensity or volume of sounds relative to some reference level. Selective attenuation can optimize sounds for typical users whose hearing sensitivity is close to “normal”, e.g., as determined data for a sufficiently large sample population. However, for some listeners, especially ones with some degree of hearing loss, it is difficult to customize such selective attenuation without some knowledge of the frequency response of the listener's sense of hearing.

Human hearing sensitivity is typically determined by procedure known as an audiogram. In this procedure, a device known as an audiometer typically transmits recorded sounds such as pure tones or speech to the headphones of the test subject at varying frequencies and intensities, and records the subject's responses to produce an audiogram of threshold sensitivity, or speech understanding profile. Persons hard of hearing often use hearing aids or cochlear implants that are configured to perform signal processing that selectively amplifies sounds according to the user's hearing sensitivity profile. Such devices are often compatible with personal area network protocols such as Open Bluetooth. Unfortunately, many audio devices do not support personal area network protocols that would otherwise permit them to connect their audio devices to their hearing aids or cochlear implants.

According to aspects of the present disclosure, a computer system, such as a video game system, may be configured to administer an audiogram and adjust audio attenuation according to the results of the audiogram. The audiogram may be administered explicitly or implicitly. In some implementations, the system may be configured to administer an audiogram in a more or less conventional manner by playing single frequency tones and recording responses indicating whether the user can hear those tones. In other implementations, the audiogram may be inferred from the user's adjustment of audio settings during normal use of the system. For example, the system can determine when the user moves the volume up or down and what audio is playing at that time and use that information to proactively refine the user audio attenuation profile at certain times when certain audio signals are played. The system could also analyze background noise, e.g., with a microphone on an audio headset and identify sounds that might affect the audio attenuation profile. The audio attenuation could be adjusted on the fly as the system monitors background noise.

Customized Selective Attenuation of Game Audio

Sound is played at 102. The sound may be played over one or more windows of time. The user's response to the sound is recorded at 104 via the user interface UI. Sound continues to be played and user responses recorded until a last sound window at 106. The sounds played for each time window may be characterized by a particular frequency or frequency range. The system may prompt the user to respond to each sound through the user interface UI. For example, the system may present a message asking the user to press a button on the interface if the user can hear the sound. The system may adjust the volume of the sound depending on the user's response. For example, if the user's response indicates that the sound was heard, the system may play the same sound at a lower volume and prompt the user again. The system may repeat this procedure until the user's response indicates that the sound is no longer heard. The process may be repeated for sounds of different frequency sub-ranges over the range of human hearing. In implementations where the user wears a headset HS with separate speakers for this ear, as illustrated, the process may be repeated for each ear.

According to aspects of the present disclosure, the audiogram procedure discussed above may be implemented separately from normal operation, e.g., normal gaming in the case of video game systems. For example, in some implementations, the audiogram procedure could be incorporated into an onboarding process, e.g., when a user first uses a new system.

Additionally, continued interaction with and use of the selective audio attenuation feature could result in the user receiving an achievement award, e.g., a trophy. For example, a bronze trophy awarded after the first time enough data has been collected that the automated selective audio attenuation algorithm goes into effect, silver for some number N of stored attenuations, gold for some number of hours of sustained use, etc. The system could also encourage users to generate audiograms by “gamifying” the audiogram process, e.g., by presenting it as a form of interactive entertainment instead of a regular UI. By way of example, the audiogram process may include an option for a user to choose from wide range game characters that guide user through the process in an interactive manner. The game characters may be associated with a particular gaming platform, e.g., Astrobot or Aloy or Kratos or Ratchet, for PlayStation® games. PlayStation® is a registered trademark of Sony Interactive Entertainment Inc. of Tokyo, Japan.

In alternative implementations, the audiogram procedure may be incorporated into normal operation of the system. For example, the system may continuously monitor the user's manual adjustment of system audio settings, e.g., volume, speaker balance, treble, or bass and perform frequency analysis on sounds that are played at the moment of adjustment. In video game implementations, the system may also monitor the context of what is happening in the game, e.g., dialogue, voice chat, music, sound effects, and associate the user's preferred audio settings with the corresponding context, e.g., in a relational data structure. In this way, data relating to the user's hearing sensitivity may be generated without having to prompt the user. The system may then infer an audiogram from such data. Furthermore, the hearing sensitivity data may be continuously updated over time, e.g., through repeated monitoring of audio setting adjustment and audio context or through repeated administration of audiograms.

In some implementations, the user action of increasing or decreasing listening device audio volume may be linked to a notifications framework. In such implementations when a user adjusts volume, e.g., using buttons on a device such as a headset, a notification GUI may pops up with a dynamic volume slider that moves left or right based on the user button press. If the system records the specific audio frequency played when the user manually adjusts volume, after some number of times of making the same adjustment for the same frequency, the GUI notification could explicitly alert the user that automated audio attenuation is now in effect. In some implementations, the GUI may instruct the user how to turn the feature on or off in settings. By way of example, the GUI may be either a simple enable/disable button, or it could be more comprehensive to allow granular control of the attenuation algorithm. For example, the GUI setting may have an expanded state that lists each discrete frequency that is now actively being modulated and allow the user to select/deselect each. Such a feature is similar to an audio equalizer, except with on/off values instead of sliding values.

Once sufficient hearing sensitivity data has been collected the system generates an audiogram 109 from the frequency spectrum of sounds played user responses associated with each window, as indicated at 108. For example, the system may record the lowest volume setting that was heard in a table cross-referenced to the frequency or frequency range of the sound that was played. In some implementations, separate audiograms may be generated for the left and right ears. The system then determines an attenuation profile 111 from the audiogram 109 as indicated at 110. The attenuation profile includes information indicating the amount of relative attenuation to be applied to audio signals as a function of sound frequency. In general, the relative attenuation may be higher in frequency ranges for which there is high sensitivity and lower in frequency ranges of low sensitivity.

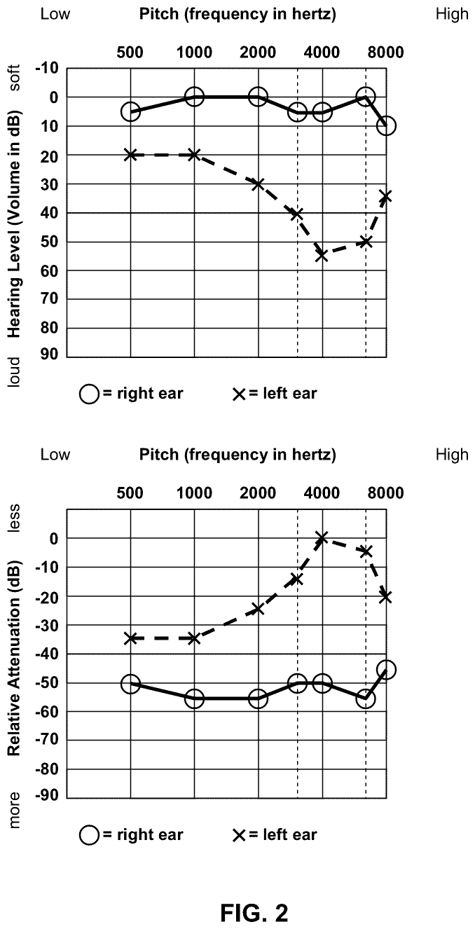

FIG. 2 illustrates a prophetic example of determining an attenuation profile from an audiogram. The upper graph in FIG. 2 shows hearing sensitivity for a hypothetical user's left ear and right ear. Hearing level in decibels (dB) is plotted versus pitch (sound frequency) in hertz (Hz). In this example, the hypothetical user has significantly lower sensitivity in the left ear with a marked decrease in sensitivity to sounds between about 1000 Hz and about 4000 Hz. The lower graph in FIG. 2 shows corresponding attenuation profiles for the hypothetical user's left and right ears. Again, relative attenuation in dB plotted versus pitch in Hz with a greater degree of attenuation indicated by a more negative value in dB. In this example, the attenuation profile for the left ear is generally characterized by less attenuation than for the more sensitive right ear and by little to no attenuation between 4000 Hz and about 7000 Hz. In the example shown, the attenuation profile for each ear has been generated by inverting the audiogram curves and shifting them so that the highest hearing level for either ear, about 55 dB for the left ear in this example, corresponds to 0 dB of attenuation. In some implementations, the attenuation profile may include positive values for certain frequencies. In the context of the attenuation profile shown in FIG. 2 a positive attenuation value for a given frequency or frequency range would correspond to amplification of sounds at that frequency or in that frequency range.

The attenuation profile 111 may account for other factors in addition to the user's hearing sensitivity. For example, the attenuation profile may be adapted on the fly to take into account the user's individual preferences. For example, the attenuation profile may increase bass (i.e., lower frequencies) for better speech perception in noisy environments. Furthermore, generating the attenuation profile may include analyzing the nature of background noise either within the game or in the external environment and adapt the attenuation profile accordingly. For example, the attenuation profile may change significantly depending on whether the real or simulated audio environment is an indoors or outdoors setting. Background noise may be monitored in a number of ways. In some implementations, the system generating the attenuation profile may include a microphone that can be configured to monitor background noise. For example, some gaming headsets include one or more microphones that can be used for monitoring background noise.

The attenuation profile 111 may be stored for later use during system operation, e.g., during a video game. In particular, the system could then run a spectrum analysis on upcoming audio output during a gaming session and adjust the audio attenuation profile to the user's hearing as determined from the audiogram. Specifically, after the game begins at 112 sound data 115 is generated as indicated at 114. In the case of video games, the sound may be synthesized or recorded and stored in compressed form. The sound data 115 generally represents sound that is played over a finite window of time over one or more audio devices. The sound data may represent different sound patterns played contemporaneously over different corresponding audio devices, e.g., different speakers of a surround sound system or headset. The sound data for each time window is analyzed at 116 to determine the spectrum of sound that will result from converting the data into corresponding signals and using the signals to produce sounds, e.g., through one or more speakers, e.g., on the headset HS. The signals may be single-channel signals or multi-channel signals, such as surround sound signals. By way of example, the attenuated signals may be 3.1, 5.1, or 7.1 surround sound signals. In some implementations, the context of the sound data may also be analyzed at 116. In video game implementations the system may continuously monitor what is happening within a game and determine a current context. The system may then compare the current context to known contexts that have associated inferred audiograms or attenuation profiles. The attenuation profile 111 may then be adjusted according to the attenuation profile for the current context, e.g., through convolution. The attenuation profile is then applied to the sound data, as indicated at 118. The resulting attenuated sound data 119 may then be played or transmitted to be played by a remote device, as indicated at 120.

The type of spectrum analysis performed at 116 depends on the format of the sound data 115. For example, the sound data may be in the form of a digitized waveform of sound intensity or level as a function of time. In such a case, the system may apply a Fourier-type transform, e.g., a Fourier transform, discrete cosine transform (DCT), or modified discrete cosine transform (MDCT) to the sound data 115. The resulting transformed data would represent sound intensity or sound level as a function of frequency. The system may analyze this data to determine which frequency or frequencies are most prominent with in the window of time corresponding to the sound data. In some implementations, the sound data 115 may be in a compressed format, which typically involves applying a Fourier-type transform to a sound waveform. In some such cases, a transform might not need to be applied to the sound data. Instead, it may be sufficient to partially decompress the sound data from the compressed format into a frequency domain representation.

By way of example, the attenuation profile 111 may be applied to the sound data 115 through a convolution process. Such audio signal convolution is often implemented in real-time synthesis of sounds in a simulation, such as a video game virtual environment. Generally, a pre-computed impulse response function that models the acoustic characteristics of a virtual room may be convolved with an input source signal in real-time to simulate the virtual environment's acoustics. In some implementations, the sound data 115 for a given time window may include a time-domain waveform transformed into the frequency domain and convolved with a corresponding frequency-domain impulse response.

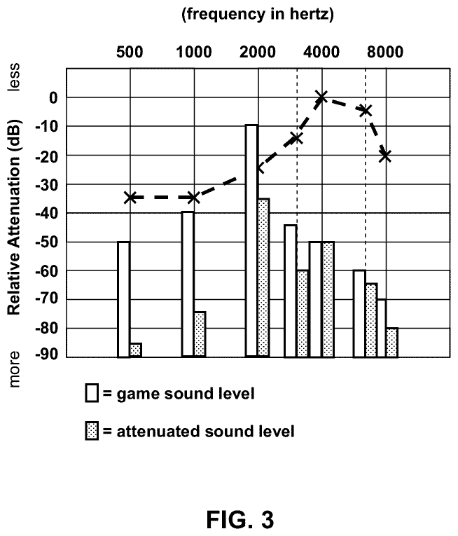

A variety of conventional techniques are available for convolving the attenuation profile and sound data. As noted above, time-domain sound waveforms may be converted into the frequency domain with a suitable transform, e.g., a discrete Fourier transform (DFT). The DFT may be performed by using a Fast Fourier Transform (FFT) algorithm on a time domain input signal. The system may then optionally perform point-wise multiplication of the resulting complex valued frequency-domain input signal and an impulse response function and the resulting frequency domain spectrum may then be convolved with the listener attenuation profile 111 by point-wise multiplication to generate the attenuated sound data 119. The graph depicted in FIG. 3 illustrates an example of attenuated sound generated from application of an audio attenuation profile to a sound signal. In FIG. 3, the white bars represent the un-attenuated sound signal level at different frequencies, the dashed line corresponds to the attenuation profile of the listener's left ear from FIG. 2, and the shaded bars represent the attenuated sound level resulting from application of the attenuation profile to the un-attenuated sound signal.

To play the attenuated sound data at 120, the resulting product may then converted back to the time domain by an inverse Fast Fourier Transform (IFFT) to generate the desired convolved and filtered signal as a function of time.

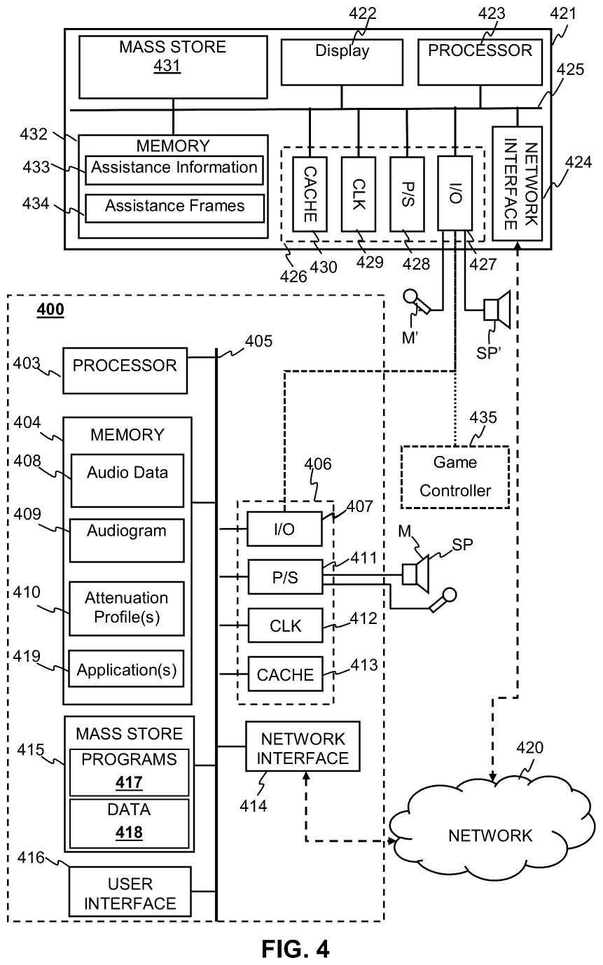

FIG. 4 diagrammatically depicts an apparatus configured to implement customized selective audio attenuation according to an aspect of the present disclosure. By way of example, and not by way of limitation, according to aspects of the present disclosure such selective audio attenuation may be implemented with a computer system 400, such as an embedded system, personal computer, workstation, game console. The computer system 400 used to implement platform feature discovery may be separate and independent of the pertinent platform, which may be an application 419 that runs on the computer system 400 or on a separate mobile device 421, such as a mobile phone, video game console, portable video game device, e-reader, tablet computer or the like. In some implementations, the platform may be the separate device 421.

The computer system 400 generally includes a central processor unit (CPU) 403, and a memory 404. The computer system may also include well-known support functions 406, which may communicate with other components of the computer system, e.g., via a data bus 405. Such support functions may include, but are not limited to, input/output (I/O) elements 407, power supplies (P/S) 411, a clock (CLK) 412 and cache 413.

Additionally, the mobile device 421 generally includes a CPU 423, and a memory 432. The mobile device 421 may also include well-known support functions 426, which may communicate with other components of the mobile device, e.g., via a data bus 425. Such support functions may include, but are not limited to, I/O elements 427, power supply (P/S) 428, a clock (CLK) 429 and cache 430. A game controller 435 may optionally be coupled to the mobile device 421 through the input/output 427. The game controller 435 may be used to interface with the mobile device 421. The mobile device 421 may also be communicative coupled with the computer system through the I/O of the mobile system 427 and the I/O of the computer system 407.

In some implementations, the I/O elements 407, 427 are configured to permit direct communication between the computer system 400 and the mobile device 421 or between the computer system or mobile device 421 and peripheral devices, such as the controller 435.

The I/O elements 407, 427 may include components for communication by wired or wireless protocol. Examples of wired communications protocols include, but are not limited to, RS232 and Universal Serial Bus (USB). Examples of wireless communications protocols include, but are not limited to Bluetooth®. Bluetooth® is a registered trademark of Bluetooth SIG, Inc. of Kirkland, Washington.

According to aspects of the present disclosure, the system 400 may optionally include one or more speakers SP, which may be integrated into a display. Alternatively, the I/O elements may be configured to accommodate one or more external speakers that are separate from the system 400. Such speakers may be incorporated into a headset. In some implementations, the system may optionally include one or more microphones M, which may be integrated into the system. Alternatively, the I/O elements may be configured to accommodate one or more external microphones that are separate from the system 400.

The computer system 400 includes a mass storage device 415 such as a disk drive, CD-ROM drive, flash memory, solid state drive (SSD), tape drive, or the like to provide non-volatile storage for programs and/or data. The computer system may also optionally include a user interface unit 416 to facilitate interaction between the computer system and a user. The user interface 416 may include a keyboard, mouse, joystick, light pen, or other device that may be used in conjunction with a graphical user interface (GUI). Among other things, the user interface 416 is configured to relay a listener's response to the audible sounds to the processor 403. The computer system may also include a network interface 414 to enable the device to communicate with other devices over a network 420. The network 420 may be, e.g., a local area network (LAN), a wide area network such as the internet, a personal area network, such as a Bluetooth® network or other type of network. These components may be implemented in hardware, software, or firmware, or some combination of two or more of these.

The Mass Storage 415 of the computer system 400 may contain uncompiled programs 417 that are loaded to the main memory 404 and compiled into executable form as the application 419. Additionally, the mass storage 415 may contain data 418 used by the processor to implement customized audio attenuation as described herein. The data 418 may include one or more relational databases containing data corresponding to one or more audiograms 408, attenuation profiles 409, and/or sound data 410. The data 418 may also include one or more impulse response functions (not shown).

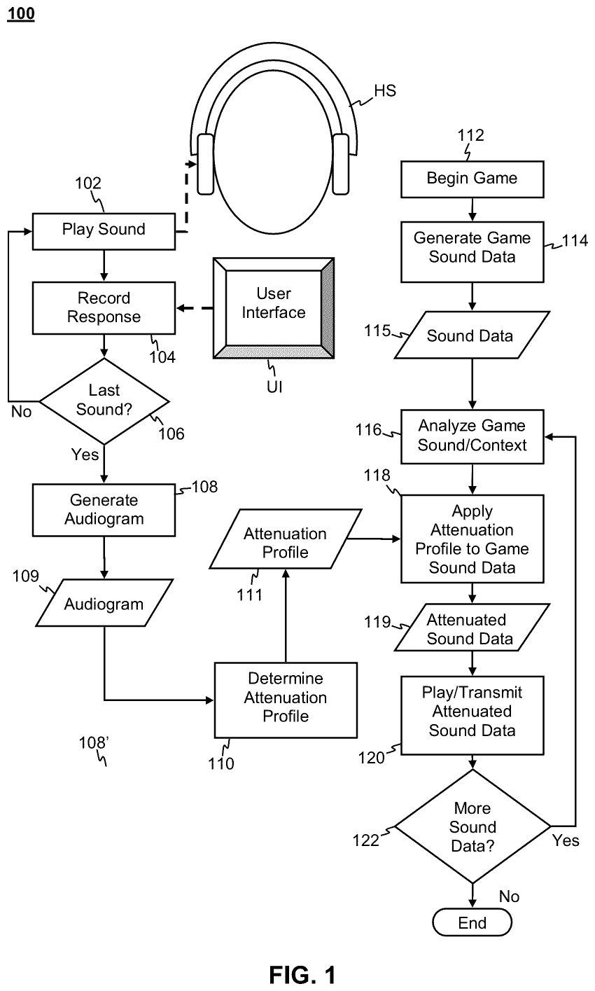

The CPU 403 of the computer system 400 may include one or more processor cores, e.g., a single core, two cores, four cores, eight cores, or more. In some implementations, the CPU 403 may include a GPU core or multiple cores of the same Accelerated Processing Unit (APU). The memory 404 may be in the form of an integrated circuit that provides addressable memory, e.g., random access memory (RAM), dynamic random-access memory (DRAM), synchronous dynamic random-access memory (SDRAM), and the like. The main memory 404 may include one or more applications 419 used by the processor 403 for example, a video game. The one or more applications may further include an application configured to generate an audiogram and attenuation profile and apply the attenuation profile to sound data as discussed above, e.g., with respect to FIG. 1. The main memory 404 may also include portions of sound data 408, audiograms 409, and/or attenuation profiles 410, which may be configured as discussed above, e.g., with respect to FIG. 2 and FIG. 3. In some implementations, one or more of the attenuation profiles may be cross-referenced to corresponding contexts, e.g., in a data table. When executed by the processor 403, one or more of the programs 419, may use the information stored in the memory 404 to implement selective audio attenuation, e.g., as described hereinabove with respect to FIG. 1, FIG. 2 and FIG. 3.

The mobile device 421 similarly includes a mass storage device 431 such as a disk drive, CD-ROM drive, flash memory, SSD, tape drive, or the like to provide non-volatile storage for programs and/or data. The mobile device may also include a user interface 422 to facilitate interaction between the mobile device or mobile trainer system and a user. The user interface may include a screen configured to display, text, graphics, images, or video. The user interface 422 may be configured to relay the listener's response to the audible sounds to the processor. In some implementations, the user interface 422 may include a touch sensitive display. The display 422 may also include one or more speakers SP′ configured to present sounds, e.g., speech, music, or sound effects. The mobile device 421 may also include a network interface 424 to enable the device to communicate with other devices over a network 420. The network 420 may be, e.g., wireless cellular network, a local area network (LAN), a wide area network such as the internet, a personal area network, such as a Bluetooth network or other type of network. These components may be implemented in hardware, software, or firmware, or some combination of two or more of these.

The CPU 423 of the mobile device 421 may include one or more processor cores, e.g., a single core, two cores, four cores, eight cores, or more. In some implementations, the CPU 423 may include a GPU core or multiple cores of the same APU. The memory 432 may be in the form of an integrated circuit that provides addressable memory, e.g., RAM, DRAM, SDRAM, and the like. The main memory 432 may temporarily store information 433, such as sound data, audiograms, attenuation profiles or context information. Such information may be collected by the mobile device 421 or retrieved from the computer system 400. A mass storage 431 of the mobile device 421 may store such when not needed by the processor 423. The mobile device 421 may be configured, e.g., through suitable programming, to display feature discovery messages generated by the computer system 400.

The CPU 403 of the computer system 400 and the mobile device 421 may be programmable general-purpose processors or special purpose processors. Some systems include both types of processors, e.g., a general purpose CPU and a special purpose GPU. Examples of special purpose computers include application specific integrated circuits. As used herein and as is generally understood by those skilled in the art, an application-specific integrated circuit (ASIC) is an integrated circuit customized for a particular use, rather than intended for general-purpose use.

As used herein and as is generally understood by those skilled in the art, a Field Programmable Gate Array (FPGA) is an integrated circuit designed to be configured by a customer or a designer after manufacturing—hence “field-programmable”. The FPGA configuration is generally specified using a hardware description language (HDL), similar to that used for an ASIC.

As used herein and as is generally understood by those skilled in the art, a system on a chip or system on chip (SoC or SOC) is an integrated circuit (IC) that integrates all components of a computer or other electronic system into a single chip. It may contain digital, analog, mixed-signal, and often radio-frequency functions—all on a single chip substrate. A typical application is in the area of embedded systems.

A typical SoC may include the following hardware components:
One or more processor cores (e.g., microcontroller, microprocessor, or digital signal processor (DSP) cores.
Memory blocks, e.g., read only memory (ROM), random access memory (RAM), electrically erasable programmable read-only memory (EEPROM) and flash memory.
Timing sources, such as oscillators or phase-locked loops.
Peripherals, such as counter-timers, real-time timers, or power-on reset generators.
External interfaces, e.g., industry standards such as universal serial bus (USB),
FireWire, Ethernet, universal asynchronous receiver/transmitter (USART), serial peripheral interface (SPI) bus.
Analog interfaces including analog to digital converters (ADCs) and digital to analog converters (DACs).
Voltage regulators and power management circuits.

These components are connected by either a proprietary or industry-standard bus. Direct Memory Access (DMA) controllers route data directly between external interfaces and memory, bypassing the processor core and thereby increasing the data throughput of the SoC. A typical SoC includes both the hardware components described above, and executable instructions (e.g., software or firmware) that controls the processor core(s), peripherals, and interfaces.

Aspects of the present disclosure provide for improved user experience through customized selective attenuation of audio in platforms such as video game systems. By determining the user's hearing sensitivity in different frequency ranges the system may proactively adjust relative attenuation of different frequency ranges in audio output. Furthermore, by utilizing a user's past history of audio attenuation and the context of such attenuation, a system may predictively adjust the system audio when similar contexts arise or are about to arise.

While the above is a complete description of the preferred embodiment of the present invention, it is possible to use various alternatives, modifications and equivalents. Therefore, the scope of the present invention should be determined not with reference to the above description but should, instead, be determined with reference to the appended claims, along with their full scope of equivalents. Any feature described herein, whether preferred or not, may be combined with any other feature described herein, whether preferred or not. In the claims that follow, the indefinite article “A”, or “An” refers to a quantity of one or more of the item following the article, except where expressly stated otherwise. The appended claims are not to be interpreted as including means-plus-function limitations, unless such a limitation is explicitly recited in a given claim using the phrase “means for.”

What is claimed is:

1. A method for customized audio attenuation, comprising:
generating audible sounds in one or more frequency ranges from electronic signals with a computer system;
inferring an audiogram for a listener from the listener's response to the audible sounds;
determining an attenuation profile from the audiogram, wherein the attenuation profile includes an attenuation level for each of the one or more frequency ranges, wherein the attenuation level for each frequency range of the one or more frequency ranges is inversely related to the listener's sensitivity to hearing sounds in that frequency range;
generating subsequent signals or data corresponding to subsequent audible sounds in the one or more frequency ranges;
applying the attenuation profile to the subsequent signals to generate attenuated signals; and
transmitting the attenuated signals to an audio transducer.

2. The method of claim 1, further comprising generating audible sounds from the attenuated signals.

3. The method of claim 1, further comprising generating audible sounds from the attenuated signals with one or more audio speakers.

4. The method of claim 1, further comprising generating audible sounds from the attenuated signals with an audio headset.

5. The method of claim 1, wherein the attenuated signals are multi-channel surround sound signals.

6. The method of claim 1, wherein the attenuated signals are 3.1 channel surround sound signals.

7. The method of claim 1, wherein the attenuated signals are 5.1 channel surround sound signals.

8. The method of claim 1, wherein the attenuated signals are 7.1 channel surround sound signals.

9. The method of claim 1, wherein inferring an audiogram for a listener from the listener's response to the audible sounds includes determining a frequency spectrum of the audible sounds and recording a change in an audio setting when the audible sounds are presented to the listener.

10. The method of claim 9, further comprising associating the audiogram with a corresponding context of the audible sounds.

11. An apparatus for, comprising:
a processor;
a memory coupled to the processor, the memory having embodied therein executable instructions that implement a method for customized audio attenuation when executed by the processor, the method comprising:
generating audible sounds in one or more frequency ranges from electronic signals with the apparatus;
inferring an audiogram for a listener from the listener's response to the audible sounds;
determining an attenuation profile from the audiogram, wherein the attenuation profile includes an attenuation level for each of the one or more frequency ranges, wherein the attenuation level for each frequency range of the one or more frequency ranges is inversely related to the listener's sensitivity to hearing sounds in that frequency range;
generating subsequent signals or data corresponding to subsequent audible sounds in the one or more frequency ranges;
applying the attenuation profile to the subsequent signals to generate attenuated signals; and
transmitting the attenuated signals to an audio transducer.

12. The system of claim 11, further comprising one or more audio speakers coupled to the processor.

13. The system of claim 11, further comprising a user interface coupled to the processor, wherein the user interface is configured to relay the listener's response to the audible sounds to the processor.

14. A non-transitory having computer executable instructions embodied therein, the instructions being configured to implement a method for customized audio attenuation when executed by the processor, the method comprising:
generating audible sounds in one or more frequency ranges from electronic signals with the apparatus;
inferring an audiogram for a listener from the listener's response to the audible sounds;
determining an attenuation profile from the audiogram, wherein the attenuation profile includes an attenuation level for each of the one or more frequency ranges, wherein the attenuation level for each frequency range of the one or more frequency ranges is inversely related to the listener's sensitivity to hearing sounds in that frequency range;
generating subsequent signals or data corresponding to subsequent audible sounds in the one or more frequency ranges;
applying the attenuation profile to the subsequent signals to generate attenuated signals; and
transmitting the attenuated signals to an audio transducer.
